(19) United States
(12) Patent Application Publication
(10) Pub. No.: US 2011/0126274 A1
(43) Pub. Date: May 26, 2011

(54) SYSTEMS AND PROCESSES FOR SECURING SENSITIVE INFORMATION

(76) Inventor: Robert E. Sadeckas, Lakewood, OH (US)

(21) Appl. No.: 13/054,837

(22) PCT Filed: Oct. 12, 2009
(86) PCT No.: PCT/US2009/060378

§ 371 Date: Jan. 19, 2011

Related U.S. Application Data
(60) Provisional application No. 61/104,960, filed on Oct. 13, 2008.

(51) Int. Cl. G06F 21/00; H04L 9/32

(52) U.S. Cl. 726/7; 726/26

(57) ABSTRACT

Securing sensitive information [200]. Sensitive information is received [202] from a client. The sensitive information is then stored [204]. A token is generated [206]. The token is associated [210] with the received sensitive information. The token is then transmitted [214] to the client.

### CROSS-REFERENCE TO RELATED APPLICATIONS

This application claims priority to and benefit of U.S. provisional patent application 61/104,960 filed Oct. 13, 2008, which is incorporated herein, in its entirety, by reference.

### FIELD

The field of the present technology relates to securing sensitive information. More particularly, embodiments of the present technology relate to securing sensitive information while allowing transactions utilizing the sensitive information,

### BACKGROUND

Currently, the storage of sensitive information, such as credit card numbers and social security numbers, is highly regulated. For example, the storage and use of credit card numbers is regulated by the Payment Card Industry Data Security Standards (PCI DSS). Compliance with these regulations is both complex and expensive.

### BRIEF DESCRIPTION OF THE DRAWINGS

The accompanying drawings, which are incorporated in and form a part of this specification, illustrate embodiments of the present technology for securing sensitive information, together with the description, serve to explain principles discussed below:

FIG. 1 is a block diagram of an example system 100 for securing sensitive information, in accordance with embodiments of the present technology.

FIG. 2 is a flowchart 200 of an example process of securing sensitive information, in accordance with embodiments of the present technology.

FIG. 3 is a flowchart 300 of an example process of storing sensitive information, in accordance with embodiments of the present technology.

FIG. 4 is a flowchart 400 of an example process of retrieving sensitive information, in accordance with embodiments of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the present technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of embodiments of the present technology. However, embodiments of the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “storing”, “generating”, “associating”, “transmitting”, “mapping”, “proceeding”, “restricting”, “providing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers. It should be appreciated that in one embodiment, the present technology may be hardware, while in another embodiment, the present technology ma be hardware and firmware, while in yet another embodiment, the present technology may be hardware and software,

### Overview

Embodiments of the present technology enable sensitive information, such as credit card numbers, to be transferred from a client to a management device and securely stored at the device. A client may be a business possessing sensitive information. In one embodiment, the management device may be associated with the client (e.g., a franchise may maintain a management device for all franchisees) and/or may be maintained by a third party. The management device may then store this transferred sensitive information, in a centralized manner. Thus, compliance with various data security regulations e.g., industry standards such as PCI DSS, government regulations, etc.) may be achieved through the centralized system of a management device rather than by a client. Thus, embodiments of the present technology enable a client (e.g., each business processing credit card numbers) to reduce costs since the client may not need to have the infrastructure to comply with the various regulations and/or to facilitate compliance.

More particularly and in brief, embodiments in accordance with the present technology receive sensitive information from a client. This sensitive information is then stored. A token is generated by the management device. The token is associated with the received sensitive information. The token is then transmitted to the client.

Thus, embodiments of the present technology enable a centralized system, instead of a client, to make the necessary changes to data in order to meet security compliance regulations, thus conserving a client's resources.

### Example Architecture of a System for Securing Sensitive Information

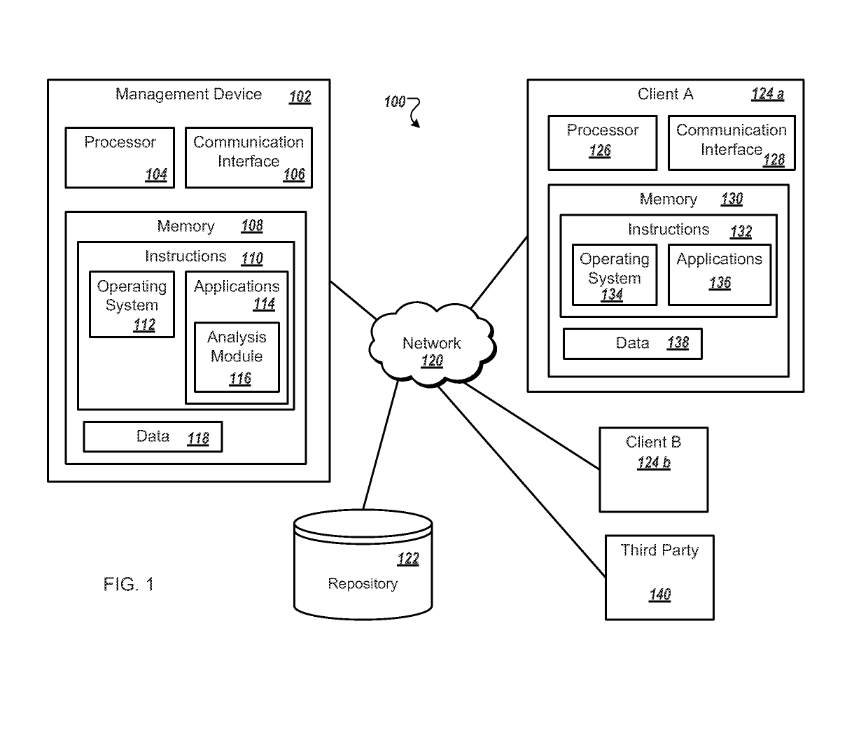

FIG. 1 is a block diagram of an example of a system 100 for securing sensitive information upon which embodiments of the present technology can be implemented. The system of FIG. 1 and each of its elements may include elements other than those shown or described herein.

In one embodiment and as illustrated, system 100 includes a management device. In one embodiment, the management device 102 may be a computer, such as a server. The management device 102 may include a processor 104 to execute various instructions and a communication interface 106 to facilitate communications with other devices, such as external repositories 122, clients 124, and/or third parties 140. The memory 108 (e.g., tangible memory, such as optical drives, flash memory, etc.) of the management device 102 may store instructions 110, such as operating systems 112 and applications 114 such as an analysis module 116. The analysis module 116 may perform various operations related to tokens. For example, the analysis module 116 may generate tokens, associate tokens with sensitive information, map associations between tokens, sensitive information, and/or user identifiers, retrieve tokens and/or sensitive information when requested, and/or prepare various reports (e.g., for audit purposes). The memory 108 may also store data 118, such as tokens, mappings, sensitive information, and/or any other appropriate data.

The management device 102 may also be coupled (e.g., through a network 120) to an external repository 122. The management device may store sensitive information, tokens, mappings, etc. in the repository 122. In some implementations, access to the external repository 122 may be restricted. For example, clients may not directly access the external repository 122. When a client desires access to sensitive information, the client may request access to the sensitive information from the management device 102. The management device 102 may verify the credentials of the client requesting access to the sensitive information (e.g., utilizing client provided user identifier and/or token). The management device 102 may access and/or retrieve the sensitive information from the external repository 122. The management device 102 may then provide the retrieved information to the client requesting the sensitive information.

Although the repository is illustrated as external and coupled to the management device 102 though a network. The repository may be directly coupled (e.g., communicably coupled, wirelessly coupled, wired, etc.) to the management device 102 and/or be a portion of the management device 102. As another example, the management device 102 may be coupled to an external repository through a private and/or secure network. Thus, access to the external repository may be inhibited.

Clients 124 (e.g., client A 124a, client B 124b) may be communicably coupled to the management device 102 through the network 120 (e.g., the Internet) Client A 124a may be a computing device, such as a personal computer. A client A 124a may include a processor 126 that executes various operations, a communication interface 128 that facilitates communications between the client A and other devices. The client A 124a also includes a memory 130 (e.g., tangible memory, such as flash memory, optical drives, etc.). The memory 130 may store instructions 132, such as operating systems 134 and applications 136, and data 138. The data 138 may include tokens, user identifiers, and/or other appropriate information. Client B 124b may also include a similar computing device.

Client A 124a and/or Client B 124b may transmit sensitive information to the management device 102. The sensitive information may be stored in a memory 108 of the management device 102 and/or in an external repository 122. The analysis module 116 may generate a token and transmit the token to the client that transmitted the sensitive information. The client may then proceed with various transactions (e.g., a process involving the sensitive information, such as storage, processing credit card transactions, credit checks, etc.) using the token instead of the sensitive information. The client may not retain a copy of the sensitive information (e.g., in memory 130), but rather request the sensitive information from the management device 102 as desired. The client may also allow third parties 140 to access the sensitive information from the management device 102.

Although the network is illustrated as a single network, the network may include a plurality of networks. For example, a first private network may couple a first client and the management device 102 and a second private network may couple a second client and the management device 102. As another example, clients 124 may access the management device 102 through the internet, and the management device may be coupled. to an external repository through a second private network. The clients may provide user identifiers, for example, to obtain access to the management device. Access to the external repository may be restricted.

### Example Operation of a System for Securing Sensitive Information

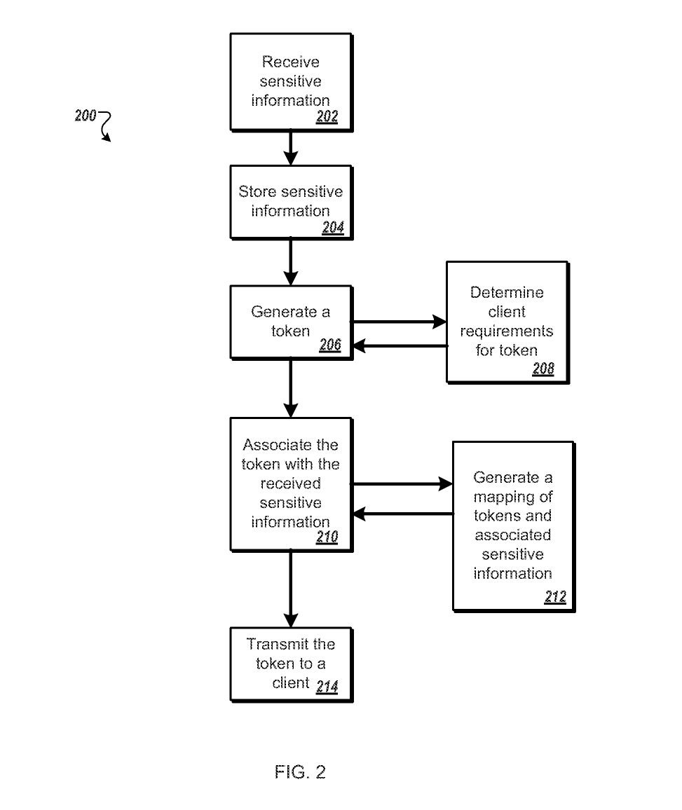

Referring to FIG. 2, a flowchart 200 of an example process for securing sensitive information is shown in accordance with embodiments of the present technology. Referring now to 202 of FIG. 2, in one embodiment sensitive information is received. For example, the management device 102 receives the sensitive information through a secure network connection with a client. Referring now to 204 of FIG. 2, in one embodiment sensitive information is stored. For example, the sensitive information may be stored in compliance with various regulations, such as industry and/or government regulations.

Referring now to 206 of FIG. 2, in one embodiment a token is generated. For example, the token may include numbers, letters, and/or combinations thereof. The token may be generated by a random number generator. Referring now to 208 of FIG. 2, in one embodiment a client's requirements for a token is determined, and the token may be generated in compliance with the client's requirements. For example, a client may request that a type of sensitive information (e.g., VISA) includes a specified character in a specified position of the sequence of characters in a token (e.g., a ‘4’ in the fourth position). As another example, a client may request that the token include characters from a specified set (e.g., real numbers). Allowing the tokens to be generated at least partially based on client requirements may allow the client to process the token in place of the sensitive information without significantly altering the client's existing processes. For example, if a client transmits a VISA number and the token includes the same attributes as the VISA number (e.g., same number of characters, same type of characters, same identifiers such as specified numbers in specified positions), then the client may process the token in the same manner as the original VISA number.

Referring now to 210 of FIG. 2, in one embodiment the generated token is associated with the received sensitive information. Referring now to 212 of FIG. 2, in one embodiment a mapping of the tokens and associated sensitive information is generated. The mapping may be stored. The mapping may also include associations between one or more user identifiers and tokens and/or sensitive information.

Referring now to 214 of FIG. 2, in one embodiment the token may be transmitted to the client (e.g., that transmitted the sensitive information).

Process 200 may be implemented by systems, such as system 100 illustrated in FIG. 1. Various operations in process 200 may be performed simultaneously, concurrently, in alternative sequences, etc. Various operations may be added, deleted, and/or modified. For example, users requesting access to sensitive information may be authenticated. The users requesting access may provide user identifiers and/or tokens associated with sensitive information. The user identifiers may be provided by the client who requested that token and/or allow tracking of the party who requests access (e.g., the management device 102 may provide user identifiers for the client to provide to other parties to request access to sensitive information). The management device 102 may compare the provided user identifier to, for example, a mapping of user identifiers associated with tokens, to verify the user identifier. As another example, the management device 102 may verify with, for example, a client that a third party should be allowed access to sensitive information (e.g., client's may provide listings of approved requesters, a request may be transmitted to a client, etc.).

In some implementations, batches of sensitive information may be received from a client and batches of tokens may be generated and provided to the client, Furthermore, batches of tokens may be received for conversion to sensitive information. The management device 102 may receive the batch of tokens, verify that the requesting party should have access to the information, determine the sensitive information associated with the tokens, and/or transmit the sensitive information to the requesting party.

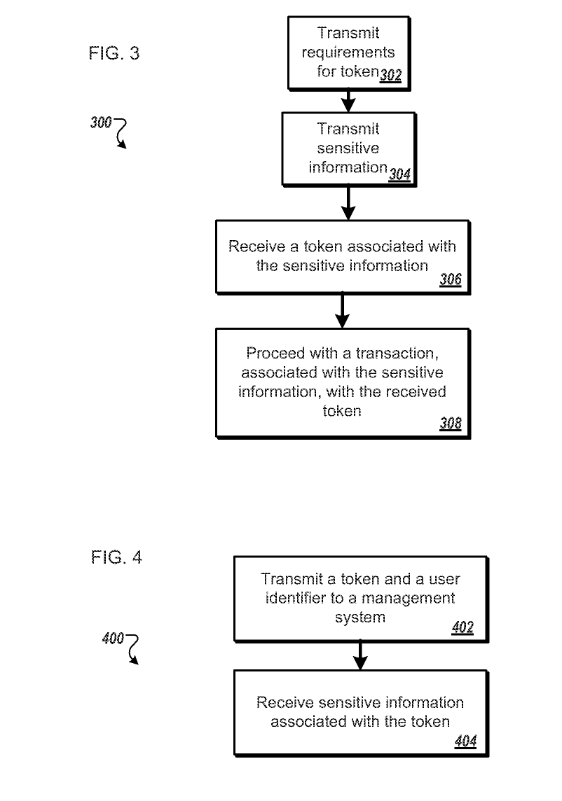

Referring now to FIG. 3, a flowchart of an example process 300 for storing sensitive information is shown in accordance with embodiments of the present technology. Referring now to 302 of FIG. 3, in one embodiment requirements for tokens are transmitted. Referring now to 304 of FIG. 3, in one embodiment sensitive formation is transmitted. For example, the sensitive information may be transmitted from a client device to the management device 102. Referring now to 306 of FIG. 3, in one embodiment a token associated with the sensitive information is received. The sensitive information associated with the token may not be retained (e.g., stored) in a system of the client. By removing the sensitive information from the client system, the client may not need to comply with the various industry and government regulations for storage of the sensitive information.

Referring no to 308 of FIG. 3, in one embodiment transactions associated with the sensitive information proceed with the received token. For example, future credit card transactions may be performed with the token in place of the sensitive information.

Process 300 may be implemented by systems, such as system 100 illustrated in FIG. 1. Various operations in process 300 may be performed simultaneously, concurrently, in alternative sequences, etc. Various operations may be added, deleted, and/or modified. For example, the sensitive information may be transmitted directly from the party to whom the sensitive information belongs (e.g., the cardholder for a credit card number) to the management device. Thus, the client may have decreased costs due to the reduced need for compliance with regulations regarding the storage of sensitive information.

Referring now to FIG. 4, an example process 400 for retrieving sensitive information is shown in accordance with embodiments of the present technology. Referring now to 402 of FIG. 4, in one embodiment, a token and a user identifier is transmitted to a management system. For example, when a client needs the sensitive information, the client may transmit a token to thee management device 102 to obtain the sensitive information. The client may transmit the token and a user identifier that identifies the client. As another example, the client may allow other parties to access the sensitive information. For example, the client may proceed with a credit check on an individual. The client may allow a credit bureau to access the sensitive information, such as a social security number, by providing the credit bureau with the token and/or a user identifier. The user identifier may identify the client and/or the credit bureau. Information related to the access to the sensitive information may be stored, for example, for audit purposes. In addition, if theft of the sensitive information occurs, the breach may be more easily identified. Referring now to 404 of FIG. 4, in one embodiment, the sensitive information associated with the token is received. For example, the management device 102 may utilize a mapping of the associations to retrieve the associated sensitive information.

Process 400 may be implemented by systems, such as system 100 illustrated in FIG. 1. Various operations in process 400 may be performed simultaneously, concurrently, in alternative sequences, etc. Various operations may be added, deleted, and/or modified. For example, user identifiers may not be required to retrieve sensitive information.

Although users (e.g., clients and/or third parties) have been described as a human, a user may be a person, a group of people, a person or persons interacting with one or more devices, such as computers, and/or devices, such as a computer system. A user device may describe one or more computers and/or computer systems. Devices may also include any appropriate electronic device, such as smart phones, personal digital assistants, laptops, desktops, etc.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes aback end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. Accordingly, other implementations are within the scope of this application.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a user identifier” includes a combination of two or more identifiers and reference “a character” includes different types of characters.

What is claimed is:

1. A computer-implemented method [200] for securing sensitive information, said computer-implemented method comprising:
receiving [202] sensitive information from a client;
storing [204] said sensitive information;
generating [206] a token;
associating [210] said token with received sensitive information; and
transmitting [214] said token to said client.

2. The computer-implemented method [200] of claim 1 , wherein said generating a token further comprises:
generating said token in compliance with one or more requirements of said client.

3. The computer-implemented method [200] of claim 1, wherein said receiving sensitive information from a client further comprises:
receiving said sensitive information through a secure network connection with said client.

4. The computer-implemented method [200] of claim 1, further comprising:
generating [212] a mapping of said token associated with said received information.

5. The computer-implemented method [200] of claim 4, further comprising:
storing a generated mapping.

6. The computer-implemented method [400] of claim 4, wherein said mapping comprises associations between one or more user identifiers and one or more of the following: said tokens and said sensitive information.

7. The computer-implemented method [400] of claim 4, further comprising:
restricting access of said client to said sensitive information by verifying a credential of said client that is requesting access to said sensitive information; and
if said credential is verified, then providing requested sensitive information to said client.

8. A system [100] for securing sensitive information, said system comprising:
a management device [102] communicably coupled with one or more clients [124a] via a network [120], said management device [102] comprising:
a processor [104] configured for executing instructions;
a communication interface [106] configured for facilitating communication between said management device [102] and other devices; and
a memory [108] configured for storing instructions and data [118] associated with said instructions, said instructions comprising an analysis module [116] configured for performing operations associated with one or more tokens.

9. The system [100] of claim 8, farther comprising a repository [122] communicably coupled with said management device [102] via said network [120], said repository [122] configured for storing a portion of said data [118] associated with said instructions.

10. The system [100] of claim 8, wherein said operations associated with said one or more tokens include generating tokens.

11. The system [100] of claim 8, wherein said operations associated with said one or more tokens include associating said one or more tokens with said sensitive information.

12. The system [100] of claim 8, wherein said operations associated with said one or more tokens include mapping associations between one or more of the following: tokens, sensitive information, and user identifiers.

13. The system [100] of claim 8, wherein said operations associated with said one or more tokens include retrieving when requested one or more of the following: said one or more tokens and sensitive information.

14. The system [100] of claim 8, wherein said data associated with said instructions include one or more of the following: said one or more tokens, mappings, and sensitive information.

15. A computer-implemented method [300] for storing sensitive information, said computer-implemented method [300] comprising:
transmitting [302] requirements for one or more tokens by a client device [124a] to a management device [102];
transmitting [304] sensitive information to said management device [102];
receiving [306] a token of said one or more tokens associated with said sensitive information by said client device from said management device; and
with a received token that is associated with said sensitive information, proceeding [308] with a transaction.
